(19) United States
(12) Patent Application Publication
(10) Pub. No.: US 2024/0250522 A1
(43) Pub. Date: Jul. 25, 2024

(54) THUNDER PROTECTION DEVICE

(71) Applicant: NIPPON TELEGRAPH AND TELEPHONE CORPORATION, Tokyo (JP)

(72) Inventors: Naomichi NAKAMURA, Tokyo (JP); Naoki HANAOKA, Tokyo (JP); Yuji HIGUCHI, Tokyo (JP); Toru TANAKA, Tokyo (JP)

(21) Appl. No.: 18/560,532

(22) PCT Filed: May 19, 2021
(86) PCT No.: PCT/JP2021/019001

§ 371 Date: Nov. 13, 2023

(51) Int. Cl. H02H 9/00

(52) U.S. Cl. CPC H02H 9/005

(57) ABSTRACT

A lightning protection device for protecting a power supply device from a lightning surge current, the lightning protection device including: a plurality of lightning arresters connected between the power supply device and a ground electrode; and
an impedance control unit to reduce impedance between the plurality of lightning arresters and the ground electrode when a common mode current is generated, and increases the impedance when a normal mode current is generated.

### TECHNICAL FIELD

The present invention relates to a lightning protection device.

### BACKGROUND ART

As a countermeasure against a case where a lightning surge enters a power supply device due to a lightning strike, it is common to install a surge protective device (SPD) in a cable of the power supply device and release the lightning surge that has entered the cable to ground. In the SPD, the internal impedance decreases due to an increase in voltage due to the lightning surge at the moment when the lightning surge enters, and the lightning surge can be released to the ground.

For example, Non Patent Literature 1 discloses a connection method in which an SPD is connected in parallel with a device to be protected, and grounding of a lightning arrester and the device to be protected is commonly connected.

### CITATION LIST

### Non Patent Literature

Non Patent Literature 1: ITU-T K.66, “Protection of customer premises from overvoltages,” November 2019

### SUMMARY OF INVENTION

### Technical Problem

However, in the conventional technique, there is a problem that when the SPD is turned into a low impedance, the cable (SPD installation portion) on the output side of the power supply device is short-circuited, the short-circuit protection function of the power supply device operates, and thereby the output of the power supply device is stopped.

An object of the disclosed technology is to suppress output stop of a power supply device while implementing countermeasures against lightning surge.

### Solution to Problem

The disclosed technology is a lightning protection device for protecting a power supply device from a lightning surge current, the lightning protection device including: a plurality of lightning arresters connected between the power supply device and a ground electrode; and an impedance control unit to reduce impedance between the plurality of lightning arresters and the ground electrode when a common mode current is generated, and increases the impedance when a normal mode current is generated.

### Advantageous Effects of Invention

It is possible to suppress output stop of the power supply device while implementing countermeasures against lightning surge.

### BRIEF DESCRIPTION OF DRAWINGS

FIG. 1 is a diagram illustrating an example of a configuration of a conventional lightning protection device.

FIG. 2 is a diagram illustrating an example of a configuration of a lightning protection device according to an embodiment of the present invention.

FIG. 3 is a first diagram illustrating an example of an operation of an impedance control unit.

FIG. 4 is a second diagram illustrating an example of an operation of an impedance control unit.

FIG. 5 is a diagram illustrating an example of an operation in a case where a short-circuit current is generated.

FIG. 6 is a first diagram illustrating an example of an operation when a lightning surge current is generated.

FIG. 7 is a second diagram illustrating an example of an operation when a lightning surge current is generated.

FIG. 8 is a third diagram illustrating an example of an operation when a lightning surge current is generated.

### DESCRIPTION OF EMBODIMENTS

Hereinafter, an embodiment of the present invention (present embodiment) will be described with reference to the drawings. The embodiments described below are merely examples, and the embodiments to which the present invention is applied are not limited to the following embodiments. Prior to describing a technique according to the present embodiment, first, a conventional technique related to the present embodiment and a problem thereof will be described.

### (Conventional Technology)

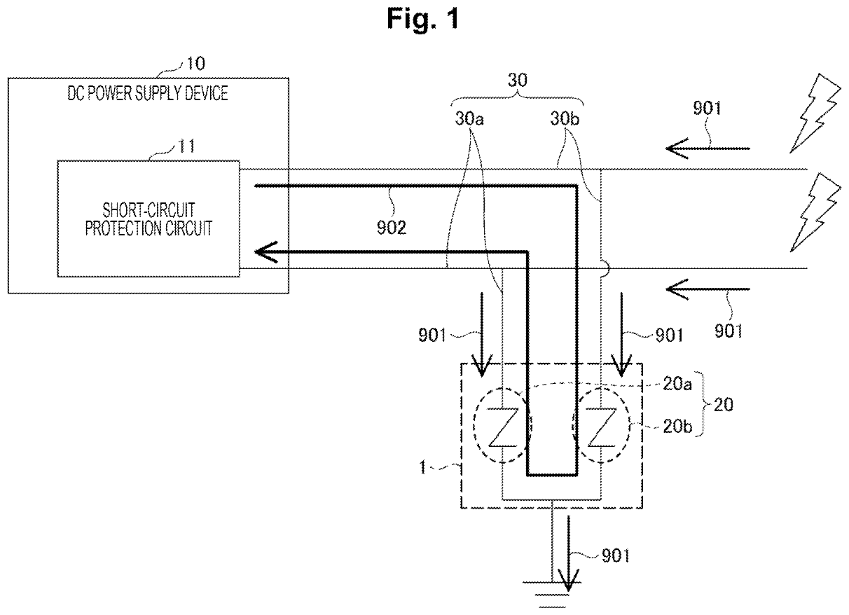

FIG. 1 is a diagram illustrating an example of a configuration of a conventional lightning protection device. The conventional lightning protection device 1 includes a surge protective device (SPD) 20a and an SPD 20b (Hereinafter, when both are not distinguished, they are referred to as an SPD 20.). The SPD 20 is a lightning arrester installed between a DC power supply device 10 and a ground electrode. The DC power supply device 10 is an example of a power supply device protected by the lightning protection device 1.

Specifically, the SPD 20a is installed between a power cable 30a on the positive electrode side of the DC power supply device 10 and the ground electrode, and the SPD 20b is installed between a power cable 30b on the negative electrode side of the DC power supply device 10 and the ground electrode.

In the configuration of FIG. 1, when a lightning surge current is generated in the direction indicated by an arrow 901 due to a lightning strike or the like, the positive electrode side and the negative electrode side are short-circuited by the operation of the SPD 20, and a short-circuit current is generated in the direction indicated by an arrow 902.

When the short-circuit current is generated, there is a problem that the output of the DC power supply device 10 is stopped by the function of a short-circuit protection circuit 11 included in the DC power supply device 10.

### (Configuration of Lightning Protection Device of Present Embodiment)

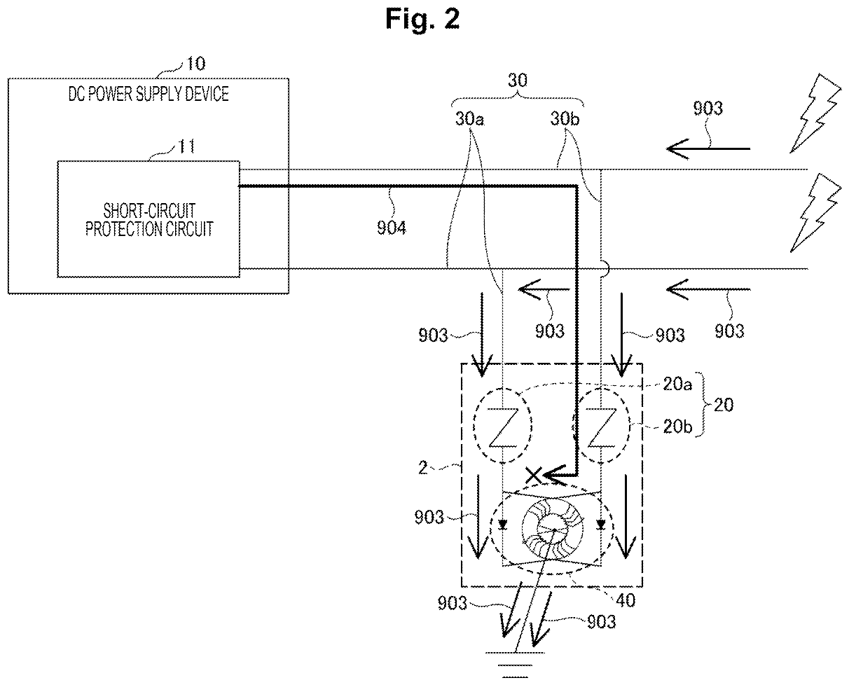

FIG. 2 is a diagram illustrating an example of a configuration of a lightning protection device according to an embodiment of the present invention. In contrast to the above-described conventional technique, a lightning protection device 2 according to the present embodiment further includes an impedance control unit 40 in addition to the SPD 20 similar to that of the conventional lightning protection device 1.

The impedance control unit 40 is an electronic circuit installed between the SPD 20 and the ground electrode and having a function of controlling the impedance of the power cable 30a and the power cable 30b. Specifically, in a case where a common mode current (for example, a lightning surge current) is generated, the impedance control unit 40 lowers the impedance so that a current easily flows to the ground electrode, and in a case where a normal mode current (for example, a short-circuit current) is generated, the impedance control unit increases the impedance so that a current between the positive electrode side and the negative electrode side hardly flows.

### (Configuration of Impedance Control Unit)

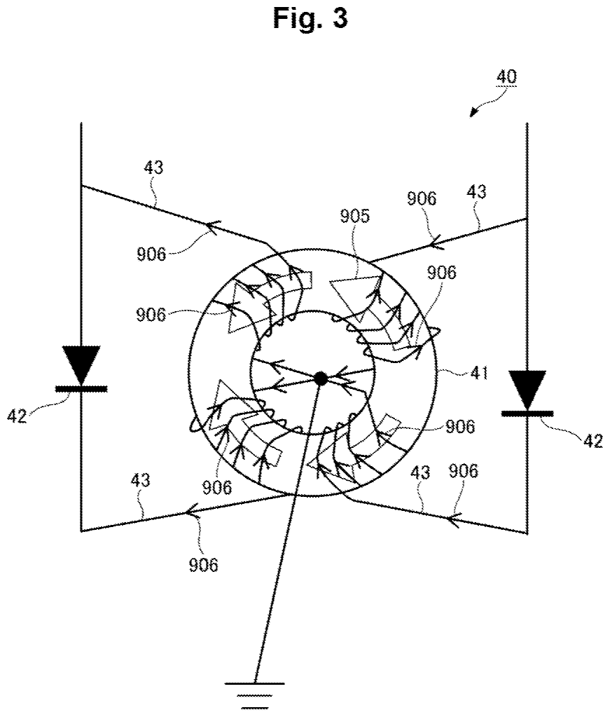

FIG. 3 is a first diagram illustrating an example of an operation of the impedance control unit. As an example, the impedance control unit 40 includes a ferrite core 41, a diode 42, and a winding 43.

Two diodes 42 are installed on ground lines connected to the SPD 20a and the SPD 20b, and four windings 43 extending from both ends of each diode 42 are wound around the ferrite core 41. The four wound windings 43 are connected to the ground electrode.

In such a configuration, when a common mode current is generated in the direction indicated by an arrow 906, magnetic fluxes in the direction indicated by an arrow 905 are generated in the ferrite core 41.

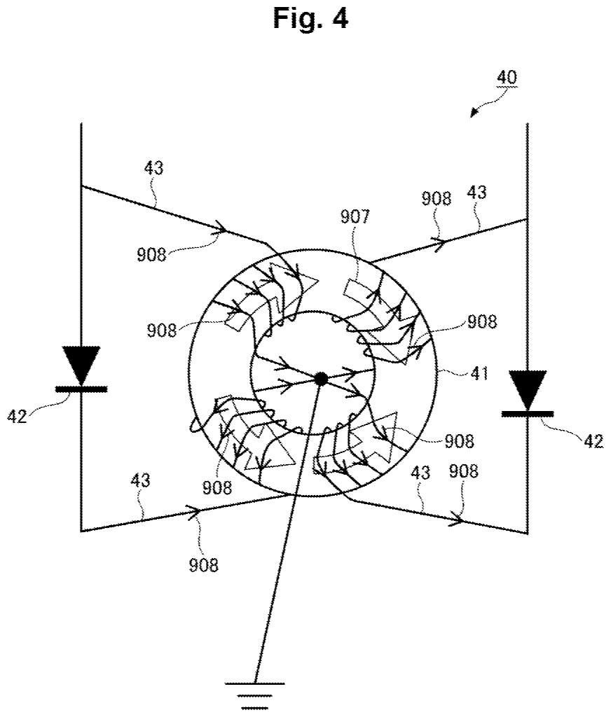

FIG. 4 is a second diagram illustrating an example of the operation of the impedance control unit. Similarly to FIG. 3, when a common mode current is generated in the direction indicated by an arrow 908, magnetic fluxes in the direction indicated by an arrow 907 are generated in the ferrite core 41.

In the magnetic fluxes in the direction indicated by the arrow 905 in FIG. 3 and the magnetic fluxes in the direction indicated by the arrow 907 in FIG. 4, the magnetic fluxes generated in the opposite directions cancel each other, so that the current easily flows through the winding 43.

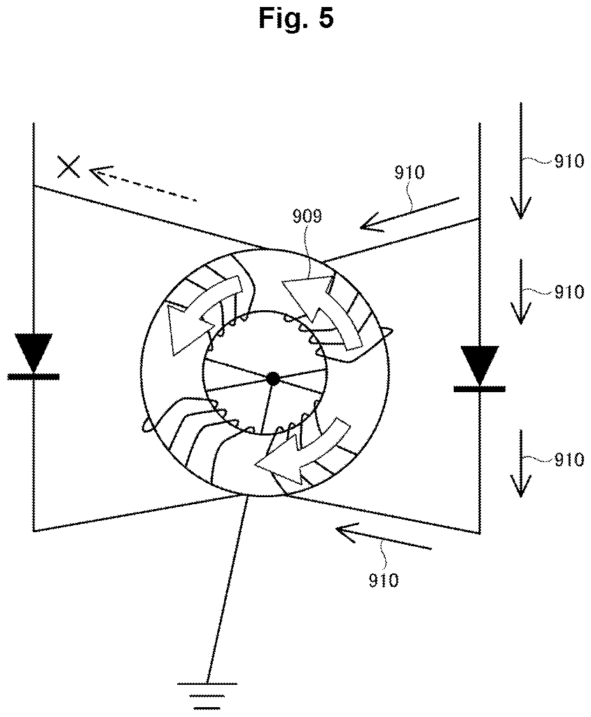

FIG. 5 is a diagram illustrating an example of an operation in a case where a short-circuit current is generated. When the normal mode current (For example, short-circuit current) in the direction indicated by an arrow 910 is generated, a part of the magnetic fluxes in the direction indicated by an arrow 909 generated in the ferrite core 41 are not canceled, and the current hardly flows through the winding 43.

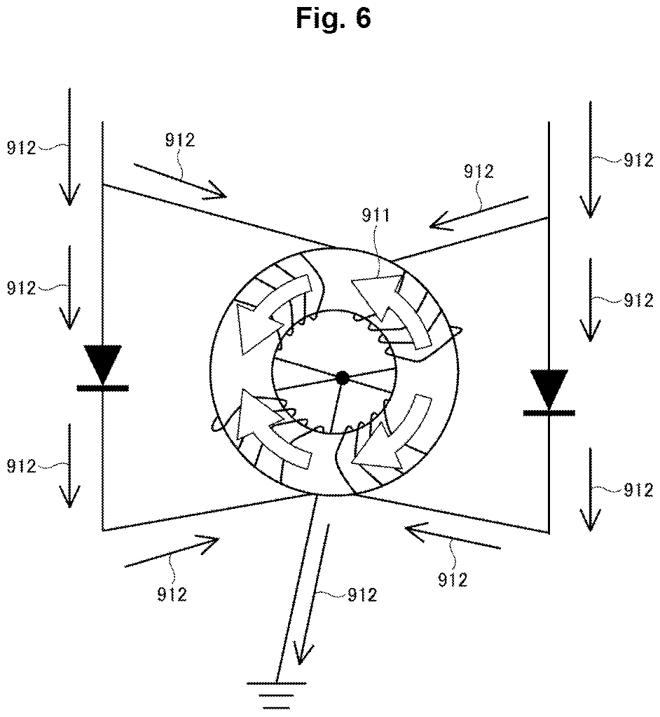

FIG. 6 is a first diagram illustrating an example of an operation when a lightning surge current is generated. When a common mode current (For example, a lightning surge current) in the direction indicated by an arrow 912 is generated on both the positive electrode side and the negative electrode side, magnetic fluxes in the direction indicated by an arrow 911 are generated in the ferrite core 41. In this case, since the generated magnetic fluxes cancel each other, the current easily flows through the winding 43, and the current to the ground electrode is not suppressed.

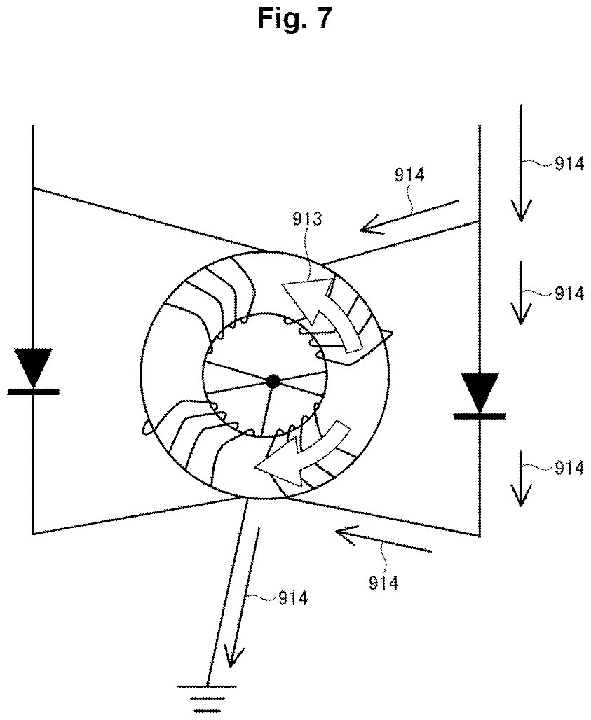

FIG. 7 is a second diagram illustrating an example of an operation when a lightning surge current is generated. When a common mode current (For example, a lightning surge current) in the direction indicated by an arrow 914 is generated on the positive electrode side, magnetic fluxes in the direction indicated by an arrow 913 is generated in the ferrite core 41. Also in this case, similarly to the case of FIG. 6, the generated magnetic fluxes cancel each other, so that the current easily flows through the winding 43, and the current to the ground electrode is not suppressed.

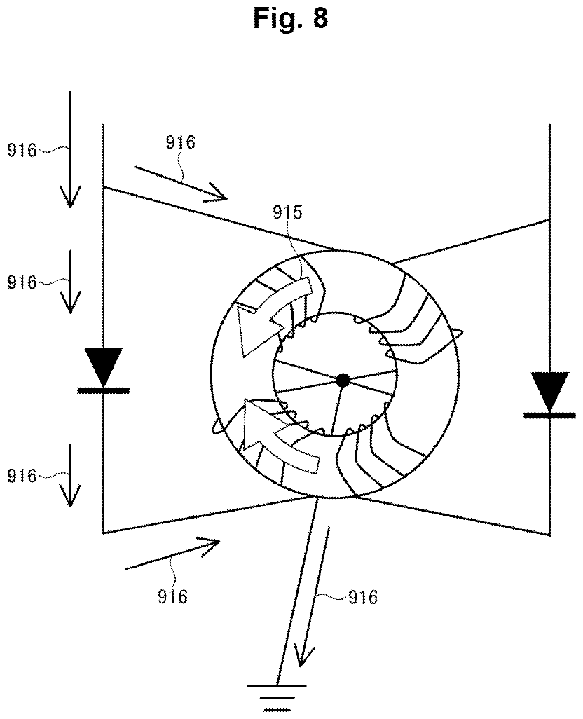

FIG. 8 is a third diagram illustrating an example of an operation in a case where a lightning surge current is generated. When a common mode current (For example, a lightning surge current) in the direction indicated by an arrow 916 is generated on the negative electrode side, magnetic fluxes in the direction indicated by an arrow 915 is generated in the ferrite core 41. Also in this case, similarly to the cases of FIGS. 6 and 7, the generated magnetic fluxes cancel each other, and thus, the current easily flows through the winding 43, and the current to the ground electrode is not suppressed.

As illustrated in FIGS. 5 to 8, when the common mode current (lightning surge current) is generated, the magnetic fluxes generated in the ferrite core 41 cancel each other, so that the impedance between the SPD 20 and the ground electrode decreases, and when the normal mode current (short-circuit current) is generated, a part of the magnetic fluxes generated in the ferrite core 41 are not canceled, so that the impedance increases.

In addition, as illustrated in FIGS. 6 to 8, when the common mode current is generated on both the positive electrode side and the negative electrode side of the DC power supply device 10 and when the common mode current is generated on either one of the positive electrode side and the negative electrode side, the impedance decreases.

In the present embodiment, as an example of the impedance control unit 40, the configuration including the ferrite core 41 around which the winding is wound and the diode 42 has been exemplified, but other configurations may be used. For example, the impedance control unit 40 may be a control circuit that measures a current value flowing through the power cable 30a and the power cable 30b, and adjusts the impedance of the resistance circuit installed between the power cable and the ground electrode by control by a computer based on the measurement result.

### Summary of Embodiment

In the present specification, at least the lightning protection devices described in the following sections are described.

### (Item 1)

A lightning protection device for protecting a power supply device from a lightning surge current, the lightning protection device including:
a plurality of lightning arresters connected between the power supply device and a ground electrode; and
an impedance control unit to reduce impedance between the plurality of lightning arresters and the ground electrode when a common mode current is generated, and increase the impedance when a normal mode current is generated.

### (Item 2)

The lightning protection device according to Item 1, in which the impedance control unit is a circuit including a ferrite core around which a winding is wound and a plurality of diodes.

### (Item 3)

The lightning protection device according to Item 2, in which
two of the plurality of diodes are installed on ground lines connected to the plurality of lightning arresters,
four windings extending from both ends of each of the plurality of diodes are wound around the ferrite core, and
the four windings are connected to the ground electrode.

### (Item 4)

The lightning protection device according to Item 2 or 3, in which when the common mode current is generated, magnetic fluxes generated in the ferrite core cancel each other, so that the impedance decreases, and when the normal mode current is generated, a part of the magnetic fluxes generated in the ferrite core are not canceled, so that the impedance increases.

### (Item 5)

The lightning protection device according to any one of Items 1 to 4, in which the impedance decreases when the common mode current is generated on both a positive electrode side and a negative electrode side of the power supply device and when the common mode current is generated on one of the positive electrode side and the negative electrode side.

Although the present embodiment has been described above, the present invention is not limited to such a particular embodiment, and various modifications and changes can be made within the scope of the gist of the present invention described in the claims.

### REFERENCE SIGNS LIST

1, 2 LIGHTNING PROTECTION DEVICE
10 DC power supply device
11 short-circuit protection circuit
20 SPD
30 power cable
40 impedance control unit
41 ferrite core
42 diode
43 winding

1. A lightning protection device for protecting a power supply device from a lightning surge current, the lightning protection device comprising:
a plurality of lightning arresters connected between the power supply device and a ground electrode;
a processor; and
a memory that includes instructions, which when executed, cause the processor to execute a method, said method including:
reducing impedance between the plurality of lightning arresters and the ground electrode when a common mode current is generated, and increasing the impedance when a normal mode current is generated.

2. The lightning protection device according to claim 1, wherein the processor is a circuit including a ferrite core around which a winding is wound and a plurality of diodes.

3. The lightning protection device according to claim 2, wherein
two of the plurality of diodes are installed on ground lines connected to the plurality of lightning arresters,
four windings extending from both ends of each of the plurality of diodes are wound around the ferrite core, and
the four windings are connected to the ground electrode.

4. The lightning protection device according to claim 2, wherein when the common mode current is generated, magnetic fluxes generated in the ferrite core cancel each other, so that the impedance decreases, and when the normal mode current is generated, a part of the magnetic fluxes generated in the ferrite core are not canceled, so that the impedance increases.

5. The lightning protection device according to claim 1, wherein the impedance decreases when the common mode current is generated on both a positive electrode side and a negative electrode side of the power supply device and when the common mode current is generated on one of the positive electrode side and the negative electrode side.
